(19) United States
(12) Patent Application Publication
(10) Pub. No.: US 2006/0221778 A1
(43) Pub. Date: Oct. 5, 2006

(54) Optical disc device and recording and reproduction methods of an optical disc device

(75) Inventors: Hidehito Nakamura, Fukuoka (JP); Kozo Yuki, Fukuoka (JP); Kazunori Shibata, Kumamoto (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/373,147

(22) Filed: Mar. 13, 2006

(30) Foreign Application Priority Data
Mar. 30, 2005 (JP) 2005-097417
Dec. 13, 2005 (JP) 2005-358742

(51) Int. Cl. G11B 21/08

(52) U.S. Cl. 369/30.01

(57) ABSTRACT

The object is to provide an optical disc drive and a recording/reproduction method for optical disc devices capable of returning to an ordinary operation, even if an over-current generates due to an instantaneous current consumption, since the power supply from a USB port is not shut down. The object is solved by the constitution which is provided with a current detection unit that detects the current flowing in from the power supplying unit of a USB port, temporarily turns off at least one of an actuator driver, feed motor driver or spindle motor driver when the inflow current exceed a pre-determined value, and sustains such temporary turn-off of at least one of the actuator driver, feed motor driver or spindle motor driver intermittently until the inflow current decreases to the threshold or below.

### BACKGROUND OF THE INVENTION

1. Field of the Invention

The present invention relates to an optical disc device having an optical pickup unit that conducts at least either of information recording or reproduction for an optical disc, and recording and reproduction methods of an optical disc device.

2. Description of the Related Art

Among peripheral apparatuses used upon being connected to an electronic device such as a computer, there are those which can receive electric power from the connected electronic device such as a computer. For example, since a universal serial bus (referred to as ‘USB’ hereinafter) has a power supply bus, there are some devices which are connected via this USB and fed with electric power via this power supply bus.

In the specification, a conventional optical disc device, which is capable of being supplied with electric power via USB, is described as an example with reference to the drawings.

FIG. 7 is a block diagram showing the configuration of a conventional optical disc device. In FIG. 7, 1 is an optical disc, 2 is a feed motor, 3 is a spindle motor, 4 is an optical pickup unit, 5 is an LD driver, 6 is a feed motor driver, 7 is a spindle motor driver, 8 is an actuator driver, 9 is a lead amplifier, 20 is a CD encoder, 11 is a CD-ROM encoder, 12 is a buffer memory, 13 is an ATIP detector, 14 is a CD-ROM decoder, 15 is a CD servo processor, 16 is a system bus, 17 is a CPU, 18 is a read only memory (ROM), 19 is a main memory, 20 is a nonvolatile memory, 21 is an interface unit, 22 is an interface bus, 23 is a power source unit, 24 is a PC power source, 25 is an AC adapter and 26 is a DIPSW.

The optical disc 1 is rotated by the spindle motor 3 whereby the optical pickup unit 4 moves in the radial direction of the optical disc 1 by means of the feed motor 2, and data recording or reading are performed for the optical disc 1. The spindle motor 3 is driven by the spindle motor driver 7, while the feed motor 2 is driven by the feed motor driver 6. The optical pickup unit 4 is driven by the actuator driver 8.

All of the feed motor driver 6, the spindle motor driver 7 and the actuator driver 8 are serve-controlled by the CD servo processor 15. A laser diode (not shown in the drawing) is installed in the optical pickup unit 4, and is driven by the LD driver 5 and controlled from the CD encoder 10. The CD-ROM encoder 11 acquires the data to be recorded from the buffer memory 12 in which the data are stored, conducts encoding processing for recording, and inputs the encoded result to the CD encoder 10.

In the reproduction system, optical signals obtained from the optical disc 1 and the optical pickup unit 4 are subjected to signal processing by the lead amplifier 9, then used as the feedback signals for the CD servo processor 15, at the same time, and becomes input signal to the ATIP detector 13, and the output signal therefrom is fed back to the CD encoder 10. The CD-ROM decoder 14, which is for demodulating the CD signal, conducts data demodulation using the output signal of the CD servo processor 15, and stores the resulting data in the buffer memory 12. The buffer memory 12 is a memory for temporarily memorizing the recording data and the demodulated data. These data pass the interface unit 21 and are exchanged with the computer in the communication using the interface bus 22.

The CPU 17 performs logical judgment and calculation. 18 is a read-only-memory (ROM), having a program memory area that memorizes control programs and the recording and reproduction control programs for the optical disc device. 19 is a main memory, which is used as a memory region necessary for recording and reproduction controls.

The system bus 16 is a data forwarding bus within the optical disc device. The power source portion stably supplies voltage to each control chip from the power source unit 23. Further, the power source unit 23 is supplied with power from the AC adaptor 25 and the PC power source 24. The PC power source 24 has a mechanism for feeding voltage to the power source unit 23 of the drive in conjunction with the voltage of the power source terminal VBUS from the interface unit 21 connected to the PC via USB, and automatically activates and finishes drive operation in conjunction with the ON/OFF of the USB power supply.

Now, the control in an optical pickup unit 4 for a conventional optical disc device is described with reference to FIG. 8.

FIG. 8 is a flowchart showing the control of a conventional optical pickup unit. When an optical disc 1 is inserted in the optical disc device, a spindle motor 3 is allowed to rotate, starting activation processing, conducts focus servo and tracking servo, and further judges the type of the optical disc 1 (S1). The tracking signal and the focus error signal from the optical disc 1 are detected by the optical pickup unit 4 installed with an optical pickup (S2), and the detected tracking error signal and the focus error signal are amplified by the lead amplifier 9 (S3). The focus error signal indicates the deviation of the light beam spot ejected from an objective lens (not shown) installed in the optical pickup unit 4 from the recording surface of the optical disc 1 in the focus direction, while the tracking error signal indicates the deviation between the light beam spot and the information track of the optical disc 1 in the radial direction of the optical disc. The amplified tracking error signal and the focus error signal are sent to the CD servo processor 15, where a tracking drive signal and a focus drive signal are formed (S4). The tracking drive signal and the focus drive signal thus formed are sent to the actuator driver 8 from the CD servo processor 15 to control the optical pickup unit 4 (S5). The optical pickup unit 4 conducts data reading and writing for the optical disc 1 (S6).

As a precedent example in this field, there are Japanese Patent Laid-open No. 39671/1999 and the like.

For the aforementioned optical disc devices connected to electronic devices such as a computer, there occur some cases where they operate with use of a limited current supplied by the connected electric device. However, the current consumed by an optical disc device is not always constant, but fluctuates, depending on, for example, the current consumed by the feed motor driver 6 or the spindle motor driver 7 which conduct the operation and control of the optical pickup unit 4 based on the focus error signal and the tracking error signal as in the case of an external attachment-type optical disc device connected via USB.

FIG. 9 is a diagram for constituting the waveform of driver current in a conventional manner. In case where, as a result of fluctuation in the consumption current of an optical disc device, the current, which is fed from the PC power source 24 via the USB port of a PC generates an over-current exceeding the allowable current limit, the M5V current as the power supply to the motor driver from the USB port of the PC is shut down, thus shutting down the optical disc device itself, just like the M5V current 801 constituted of the waveform of the conventional driver current as shown in FIG. 9.

### SUMMARY OF THE INVENTION

The invention has been devised to solve the above-mentioned problem, and thus has an object of providing an optical disc device in which, even if an over-current occurs due to instantaneous current consumption, the power supply from a USB port is not shut down, and which accordingly is not shut down, and can easily return to ordinary operation. The invention is an optical pickup controller that conducts one of tracking servo control and focus servo control of an optical pickup unit, a connector that is connected to an external device and is supplied with electric power from the external device via the connector, a detector that detects a current of electric power supplied from the external device, and a controller that turns off the control of the optical pickup unit, when the detector detects that the current exceeds the pre-determined threshold.

By virtue of such a constitution, even if vibration of the optical disc device occurs due to an external cause to increase the focus error or tracking error, it now becomes possible to monitor the inflow current from an external device and control the current to a level that the external device can afford. Moreover, even when the inflow current exceeds a pre-determined threshold caused by the current increase due to an external cause such as an impact to the optical disc device, serious eccentricity of an optical disc medium or tracking error correction due to a defect, the load to the motor or the like can be temporarily restricted. Thus, the current never exceeds the level that the external device can afford and the system can cope with the aforementioned cases corresponding to the feeding capability of the external device.

By virtue of the aforementioned constitution, the optical disc device of the invention does not suffer from the shut down of power supply from a USB port even if an over-current occurs due to an instantaneous current consumption caused by, for example, instantaneously application of an external vibration to the optical disc device to increase the tracking error or focus error, and accordingly can readily return to an ordinary operation without shut down of the system.

### BRIEF DESCRIPTION OF THE DRAWINGS

FIG. 1 is an outward appearance of an optical disc device associated with the embodiment of the invention.

FIG. 2 is a block diagram showing the constitution of the optical disc device associated with the embodiment of the invention.

FIG. 3 is a block diagram showing the over-current detection unit of the optical disc device associated with the embodiment of the invention.

FIG. 4 (a), (b) are diagrams showing the standby signal and the motor drive current associated with the embodiment of the invention.

FIG. 5 is a flow chart showing the activation processing associated with the embodiment of the invention.

FIG. 6 is a flow chart showing the method of detecting over-current associated with the embodiment of the invention.

FIG. 7 is a block diagram showing the constitution of a conventional optical disc device.

FIG. 8 is a flowchart showing the control of a conventional optical pickup unit.

FIG. 9 is a diagram of the waveform construction for conventional driver current.

### DESCRIPTION OF THE PREFERRED EMBODIMENTS

The invention set forth in claim 1 is an optical pickup controller that conducts one of tracking servo control and focus servo control of an optical pickup unit, a connector that is connected to an external device and is supplied with electric power from the external device via the connector, a detector that detects a current of electric power supplied from the external device, and a controller that turns off the control of the optical pickup unit, when the detector detects that the current exceeds the pre-determined threshold. By virtue of such a constitution, even if vibration happens to occur for the optical disc device due to an external cause to increase the focus error or tracking error, it now becomes possible to monitor the inflow current from an external device and control the current to a level that the external device can afford. Moreover, even when the inflow current exceeds a pre-determined threshold caused by the current increase due to an external cause such as an impact to the optical disc device, serious eccentricity of an optical disc medium or tracking error correction due to a defect, the load to the motor or the like can be temporarily restricted. Thus, the current never exceeds the level that the external device can afford and the system can cope with such cases corresponding to the feeding capability of the external device.

The invention set forth in claim 2 is wherein the optical pickup controller has a feed motor driver, a spindle motor driver and an actuator driver, the controller turns off at least one of the feed motor driver, the spindle motor driver or the actuator driver. By temporarily stopping one or all of the motors suffering a high load, the abruptly incoming current can be easily reduced.

The invention set forth in claim 3 is the optical disc device set forth in claim 1 wherein, when the detector detects that the current exceeds the pre-determined threshold, control of the optical pickup unit is terminated in plural times. Thus, by monitoring the inflow current over a long period of time, it becomes possible that one can control the current until it reduces to below the pre-determined threshold. Moreover, even to such a vibration due to an external cause that lasts over a long period of time, or in case where a certain disorder happens to exist in the optical disc medium, it becomes possible to maintain the current supplying capability of the external device within a pre-determined value.

The invention set forth in claim 4 is the optical disc device set forth in one of claims 1 to 3 wherein the connector means is a USB (universal serial bus), and the external device to be connected by the connector is a computer. Such a device can be used as an optical disc device of external attachment type connected by a USB cable to, for example, a notebook-type host computer, and can cope with the impact caused by dropping during usage.

The invention set forth in claim 5 is an optical disc device of external attachment type connected to a computer via a USB port comprising a spindle motor that rotates an optical disc, an optical pickup unit that records information or reproducing information in the optical disc, a feed motor that roughly shifts the optical pickup unit in a radial direction of the optical disc, a spindle motor driver that drives the spindle motor, an actuator driver that drives the optical pickup unit, a feed motor driver that drives the feed motor, and a detector that detects a current to the spindle motor, the actuator driver or the feed motor driver from the USP port; wherein, when the detector detects that the current exceeds a pre-determined threshold, the optical disc device intermittently turns off one of the spindle motor driver, the actuator driver or the feed motor driver until the current reduces to a value below the threshold.

With such a constitution, even if the tracking error or focus error increases due to the instantaneous application of, for example, external vibration to the device, and an over-current generates due to instantaneous current consumption, the power supply from the USB port of the host computer is not shut down, thus the optical disc device is not shut down and can readily return to an ordinary operation.

The invention set forth in claim 6 is the optical disc device set forth in one of claims 1 to 5, wherein the controller turns off the control of the optical pickup unit and, at the same time, turns off the recording or reproduction with the optical pickup unit. With such a constitution, recording or reproduction after the temporal turn off can be performed with ease.

The invention set forth in claim 7 is a recording and reproducing methods of an optical disc device having an optical pickup controller controlling the tracking servo or the focus servo of the optical pickup unit, wherein, when a detector that detects a current of electric power supplied from the external device via the connector, detects that the current exceeds a pre-determined threshold, control of the optical pickup unit is temporarily terminated.

With such a method, even if the tracking error or focus error increases by instantaneous application of an external vibration to generate an over-current due to instantaneous current consumption, power supply from the USB port of the host computer is not shut down, and thus the optical disc device is not shut down and can readily return to an ordinary operation.

### EMBODIMENT

In the following, one embodiment of the invention is described with reference to the drawings.

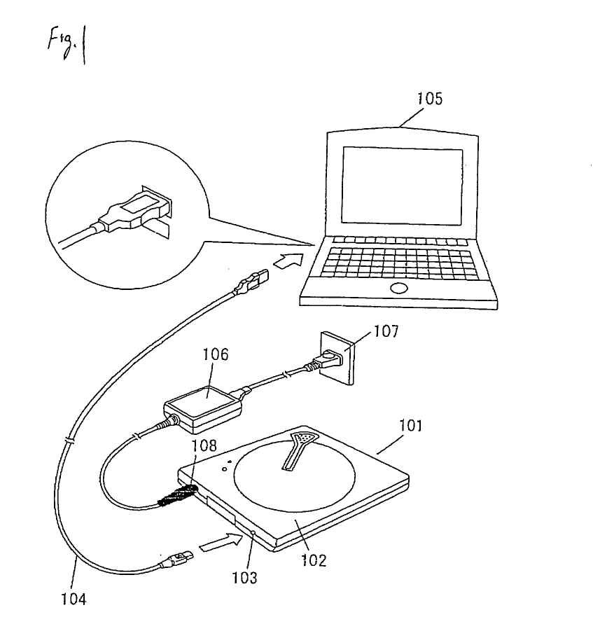

FIG. 1 is an outward appearance of an optical disc device associated with the embodiment of the invention.

In FIG. 1, 101 is an optical disc device, 102 is a top cover, 103 is a connector for USB connection, 104 is a USB cable, 105 is a computer, 106 is an AC adaptor, 107 is an electric outlet, and 108 is a DC jack.

The optical disc device 101 is so-called external attachment type not installed in an electronic device such as the computer 105, and an optical disc is mounted by opening the top cover 102. 103 is a connector for USB connection. By connecting the optical disc device to, for example, the computer 105 via the USB cable 104, the computer 105 can read data from the optical disc or can write data in the optical disc. 106 is an AC adaptor, and reduces, rectifies and flattens the voltage from the outlet 107 for a commercially available power source (for example, 100 V) and supplies current to the optical disc device 101 from the DC jack 108.

Usually, current acquirement of the external attachment type optical disc device 101 depends on a power source bus, but beside, depends in some cases on an AC adaptor 106. Whether the power source bus of the USB cable 104 can constantly supply current supply required by the optical disc device 101 mainly depends on the current supplying capability of the computer 105 and the consumption current of the optical disc device 101. In optical discs, CD-ROM, CD-R/RW, DVD-ROM, DVD-RAM, DVD-R/RW and DVD+R/RW are included, and the optical disc device 101 can cope with one or several kinds of these types of optical discs.

Meanwhile, such a configuration as to directly connect a commercially available power supply by means of a suitable wire and a connector may also be utilized so long as a power source circuit, which converts the current and voltage to values suited for use inside the optical disc device 101 is provided, without resorting to the AC adaptor 106. Furthermore, without using a commercially available power supply, batteries installed in or externally attached to the optical disc device 101 may be used as the driving power source. In consideration of saving the bother of connecting a number of cables for the operation of the optical disc device 101 and user convenience, the device is preferably driven only by the power supply bus of the USB cable 104.

Usually, the USB cable 104 connects an electronic device such as the computer 105 to the optical disc device 101 with one connecting terminal on each side of the two. But, in some cases, the number of the terminal at the side of the electronic device such as the computer 105 may be plural. With such a configuration, the allowance range for the current supplied from the electronic device to the optical disc device via the USB cable 104 can be enhanced.

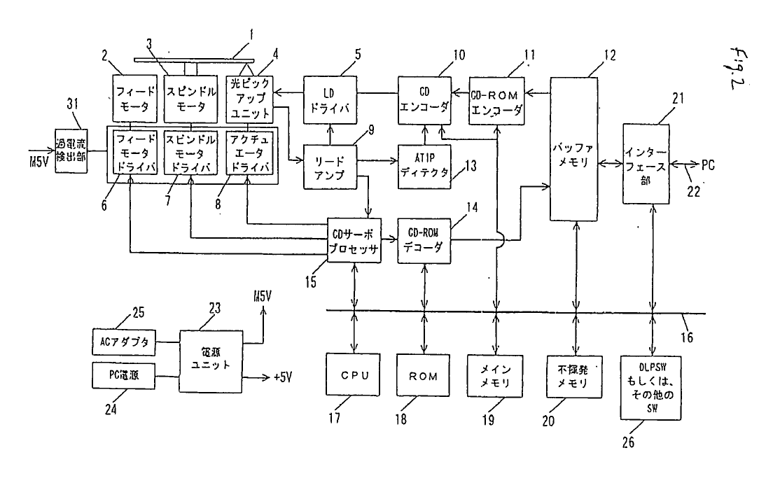

FIG. 2 is a block diagram showing the constitution of the optical disc device associated with the embodiment of the invention.

In FIG. 2, 1 is an optical disc, 2 is a feed motor, 3 is a spindle motor, 4 is an optical pickup unit, 5 is an LD driver, 6 is a feed motor driver, 7 is a spindle motor driver, 8 is an actuator driver, 9 is a lead amplifier, 10 is a CD encoder, 11 is a CD-ROM encoder, 12 is a buffer memory, 13 is an ATIP detector, 14 is a CD-ROM decoder, 15 is a CD servo processor, 16 is a system bus, 17 is a CPU, 18 is a read-only-memory (ROM), 19 is a main memory, 20 is a non-volatile memory, 21 is an interface unit, 22 is an interface bus, 23 is a power source unit, 24 is a PC power source, 25 is an AC adaptor and 26 is a DIPSW.

The optical disc 1 is rotated by the spindle motor 3. The optical pickup unit 4 is moved by the feed motor 2 in the radial direction of the optical disc 1 for rough tuning, and finely tuned by the actuator driver 8 whereby data writing or reading is conducted for the optical disc 1. The spindle motor 3 is driven by the spindle motor driver 7, and the feed motor 2 is driven by the feed motor driver 6. Further, the optical pickup unit 4 is driven by the actuator driver 8.

The feed motor driver 6, the spindle motor driver 7 and the actuator driver 8 are servo-controlled by the CD servo processor 15. In the optical pickup unit 4, a laser diode is installed (not shown in the drawing), which is driven by the LD driver 5, and controlled by the CD encoder 10. The CD-ROM encoder 11 obtains data to be recorded from the buffer memory 12 in which data are stored, conducts encoding processing and inputs the result of such processing to the CD encoder 10.

In the reproduction system, optical signals acquired from the optical disc 1 and the optical pickup unit 4 are subjected to signal processing in the lead amplifier 9, used as the feedback signal for the CD servo processor 15, and, at the same time, acts as input signal for the ATIP detector 13. The output signal therefrom is fed back to the CD encoder 10. The CD-ROM decoder 14, which demodulates CD signal, conducts data demodulation by using the output signal of the CD servo processor 15 whereby the result is stored in the buffer memory 12. The buffer memory 12 is used to temporarily memorize the recording data and demodulated data. These data go through the interface unit 21 and are exchanged with the computer in the communication using the interface bus 22.

The CPU 17 performs logical judgment and calculation and puts control programs into practice. 18 designates a read-only-memory (ROM), which has a program memorizing area which memorizes the control programs and recording control program for the optical disc recording device. 19 is a main memory and used as a memory region necessary for recording control and reproduction control.

In the present configuration, the CPU 17 is the control unit in the invention. The signals sent from each of the CD encoder 10, the CD-ROM encoder 11, the buffer memory 12, the CD-ROM decoder 14, the CD servo processor 15, the ROM 18, the main memory 19, the non-volatile memory 20 and the interface unit 21 are inputted to the CPU, which performs calculation operation on these signals, transmits the results (signals) of the calculation operation to each unit, and lets each unit carry out driving and processing to control each unit.

The system bus 16 is used for data transport within the optical disc device 101. The power supply unit stably supplies voltage to each control chip from the power supply unit 23. Further, the power source unit 23 is fed with the power from the AC adaptor 25 or the PC power source 24. The PC power source 24 has a mechanism of supplying voltage to the power source unit 23 of each drive coupled with the voltage of the source terminal VBUS from the interface unit 21 USB-connected to the PC, and thus automatically turns on and off the drives in conjunction with the ON/OFF of the USB power source,

In the present embodiment, since, in case of the standard use condition, control of the optical disc device 101 is conducted so as to be driven only by the power supply bus of the USB cable 104, current supply via the AC adaptor 25 is unnecessary. Current is supplied to the feed motor driver 6, the spindle motor driver 7 and the actuator driver 8 via the over-current detection unit 31. Here, the term ‘standard use condition’ means a low consumption current mode. By virtue of such a constitution, in the use of the optical disc device 101, the bother of connecting a number of cables thereto can be saved, thus improving user convenience.

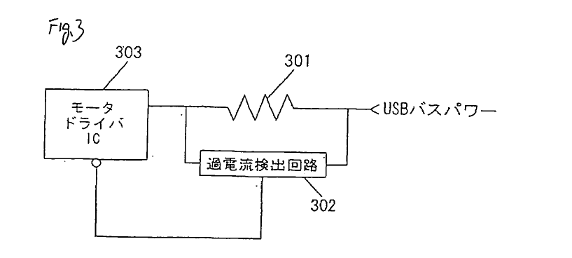

FIG. 3 is a block diagram of the over-current detection unit for the optical disc device associated with the embodiment of the invention. As shown in FIG. 3, an over-current detection resistor 301 and an over-current detection circuit 302 for over-current detection are arranged in the transmission path directed from the bus power part of the USB bus to a motor driver IC 303 installing the feed motor driver 6, the spindle motor driver 7 and the actuator driver 8. Though the optical disc device 101 of external attachment type is convenient since size and weight reductions thereof are attempted for good portability, there sometimes occurs that, during handling the device, i.e., for example, during recording or reproduction of the information in an optical disc, the user accidentally contacts the optical disc device 101. With such contact, focusing error or tracking error sometime tends to increase. To correct the focus error or tracking error, a large current is needed to flow through the feed motor driver 6 and the actuator driver 8 whereby the inflow current from the USB bus must be increased. The allowable current from the USB bus is usually defined 500 mA at maximum, but many of actual host computers have some current margins.

When the inflow current from the USB bus exceeds the pre-determined value, the over-current detection circuit 302 turns off the motor driver IC 303 by setting the standby signal level of the motor driver IC 303 to a low value. Though the motor driver IC 303 sometimes installs all the feed motor driver 6, the spindle motor driver 7 and the actuator driver 8, these drivers may be constituted individually. And, in case where the inflow current of the USB bus exceeds the pre-determined value, such a constitution may be adopted that, instead of temporarily turning off all the motor drivers (the feed motor driver 6, the spindle motor driver 7 and the actuator driver 8), at least one of them is temporarily turned off.

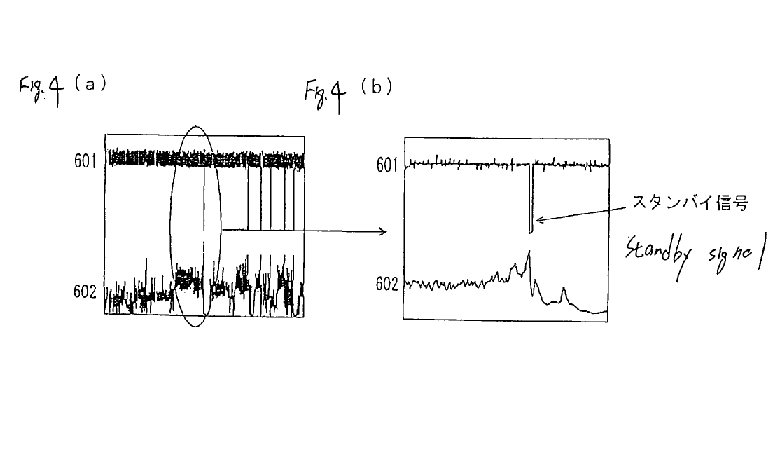

FIG. 4 is a diagram showing the standby signal and the motor drive current associated with the embodiment of the invention.

In FIG. 4, 601 designates standby signal, and 602 designates the current (M5V current) flowing in the motor drive IC. FIG. 4 (b) is an enlarged diagram of FIG. 4 (a). As shown in the drawings, by set the standby signal to LOW level, the M5V current 602 is temporarily turned off, and recording and reproduction are stopped temporarily.

As shown in FIG. 4 (a), in case where the M5V current 602 exceeds the pre-determined value, the standby signal 601 is intermittently set at LOW level to reduce the M5V current 602 to a value below the predetermined value.

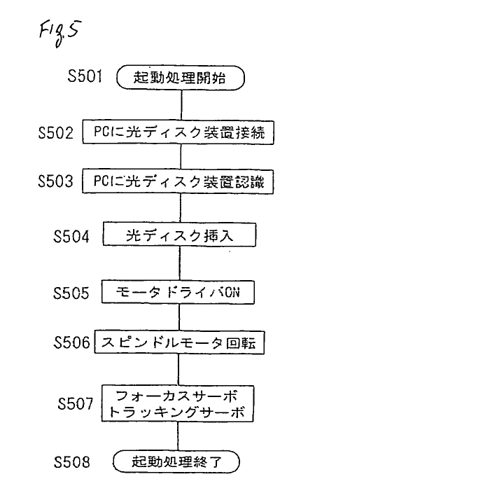

FIG. 5 is a flow chart showing the activation process associated with the embodiment of the invention.

By starting activation processing (S501), the optical disc device 101 is connected to connector 103 for USB connection of the computer 105 by means of the USB cable 104 (S502). Then, the computer 105 recognizes the optical disc drive 101 (S503). Insertion of an optical disc to the optical disc device 101 (S504) activates the spindle motor driver 7 (S505) to rotate the spindle motor 3 (S506), activate focus servo and tracking serve (S507), and the activation processing completes (S508).

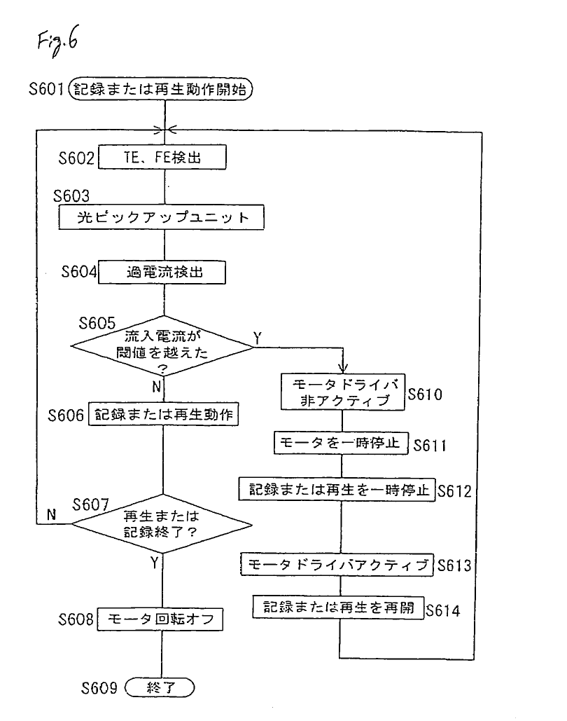

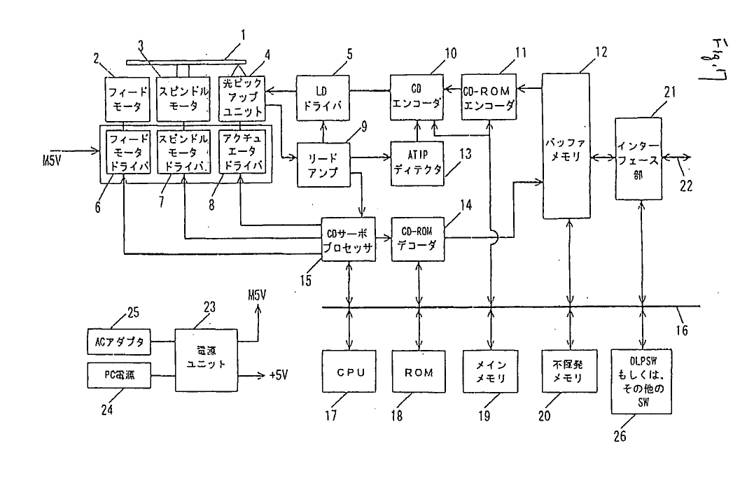

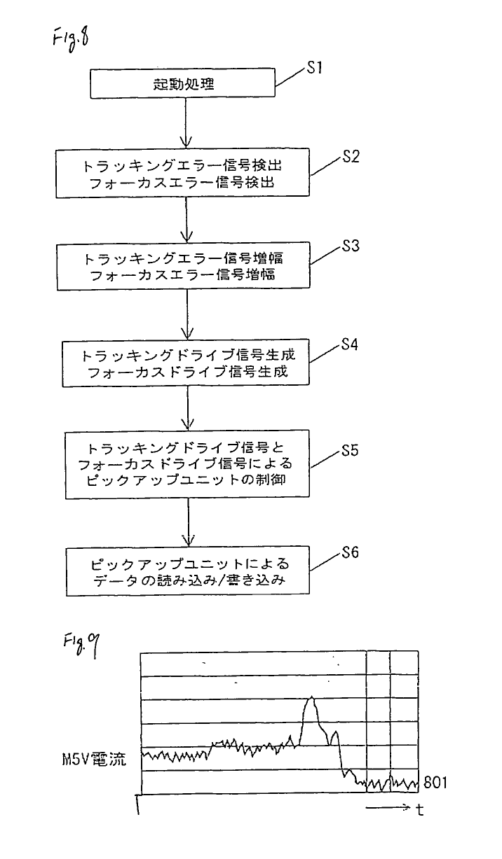

FIG. 6 is a flow chart for the over-current detecting method associated with the embodiment of the invention.

When recording operation or reproduction operation is started (S601), tracking error (TE) and focus error (FE) are detected (S602) to control the optical pickup unit 4 (S603). The inflow current from the computer 105 is detected with the activated over-current detection circuit (S604), and judgment is made whether the inflow current exceeded a threshold, for example, 500 mA, or not (S605). If the current does not exceed it, recording or reproduction operation is conducted (S606), and when the reproduction or recording completes (S607), motor rotation is stopped (S608) to finish recording or reproduction (S609). If the reproduction or recording is not finished yet (S607), the system returns to S602.

If the inflow current exceeds the threshold (S605), the spindle motor driver 7 is deactivated (S610) to stop the spindle motor 3 (S611), whereby the recording or reproduction is temporarily turned off (S612) . Then, the spindle motor driver 7 is activated (S613) to restart recording or reproduction (S614) to return to S602. Here, by setting the deactivated period of the motor driver IC 303 at a pre-determined value, at least one of the actuator driver 8, the feed motor driver 6 and the spindle motor driver 7 is temporarily and intermittently turned off to temporarily stop recording or reproduction until the inflow current reduces to the threshold value or less. In this manner, monitoring of the inflow current is continued to accelerate the return to an ordinary operation.

According to the present embodiment, the pre-determined current threshold can be made variable corresponding to the current supplying capability of the bus power of the computer. However, the scope of the invention is not limited to the type in which the threshold is variable depending on the supplying capability. Moreover, the threshold may be varied depending on the speed of recording or reproduction for an optical disc.

According to the invention, even in the case where no margin for the allowable current of the current supplying source exists for the instantaneous current consumption, the operable control method for the optical pickup can be performed without exceeding the allowable range of the current supplying source. Thus, the invention is applicable to optical disc devices of external attachment type that carry out at least one of information recording or reproduction for an optical disc.

This application is based upon and claims the benefit of priority of Japanese Patent Application No 2005-097417 filed on Mar. 30, 2005 and Japanese Patent Application No 2005-358742 filed on Dec. 13, 2005, the contents of which is incorporated herein by references in its entirety.

What is claimed is:

1. An optical disc device, comprising:
an optical pickup controller that conducts one of tracking servo control and focus servo control of an optical pickup unit;
a connector that is connected to an external device and is supplied with electric power from the external device via the connector;
a detector that detects a current of electric power supplied from the external device; and
a controller that turns off the control of the optical pickup unit, when the detector detects that the current exceeds the pre-determined threshold.

2. The optical disc device set forth in claim 1,
wherein the optical pickup controller has a feed motor driver, a spindle motor driver and an actuator driver;
the controller turns off at least one of the feed motor driver, the spindle motor driver and the actuator driver.

3. The optical disc device set forth in claim 1,
wherein, when the detector detects that the current exceeds the pre-determined threshold, control of the optical pickup unit is terminated in plural times.

4. The optical disc device set forth in claim 1, wherein the connector is a USB (universal serial bus), and the external device to be connected by the connector is a computer.

5. A optical disc device of external attachment type connected to a computer via a USB port, comprising:
a spindle motor that rotates an optical disc;
an optical pickup unit that records information or reproducing information in the optical disc;
a feed motor that roughly shifts the optical pickup unit in a radial direction of the optical disc;
a spindle motor driver that drives the spindle motor;
an actuator driver that drives the optical pickup unit;
a feed motor driver that drives the feed motor; and
a detector that detects a current from the USP port to the spindle motor, the actuator driver or the feed motor driver;
wherein, when the detector detects that the current exceeds a pre-determined threshold, the optical disc device intermittently turns off one of the spindle motor driver, the actuator driver or the feed motor driver until the current reduces to a value below the threshold.

6. The optical disc device set forth in claim 1, wherein the control turns off control of the optical pickup unit and at the same time turns off the recording or reproduction conducted by the optical pickup unit.

7. A recording and reproducing methods of an optical disc device having an optical pickup controller controlling the tracking servo or the focus servo of the optical pickup unit,
wherein, when a detector that detects a current of electric power supplied from the external device via the connector, detects that the current exceeds a pre-determined threshold, control of the optical pickup unit is temporarily terminated.
